(19) United States
(12) Patent Application Publication
(10) Pub. No.: US 2025/0123846 A1
(43) Pub. Date: Apr. 17, 2025

(54) PARALLEL PROCESSING FOR SPARSE MATRIX LINEAR ALGEBRA

(71) Applicant: Advanced Micro Devices, Inc., Santa Clara, CA (US)

(72) Inventors: William Peter Ehrett, Austin, TX (US); Muhammad Osama, Folsom, CA (US); Bradford Beckmann, Bellevue, WA (US)

(73) Assignee: Advanced Micro Devices, Inc., Santa Clara, CA (US)

(21) Appl. No.: 18/485,502

(22) Filed: Oct. 12, 2023

(51) Int. Cl. G06F 9/38

(52) U.S. Cl. CPC G06F 9/3889

(57) ABSTRACT

A processing unit includes a plurality of processing cores and is configured to arrange a sparse matrix for parallel performance by the cores on different rows of the matrix at least in part by calculating a respective quantity of non-zero elements in each row, assigning each row to a respective collection according to the respective quantity of non-zero elements for the row, wherein the processing unit is configured to assign at least one first row of the sparse matrix to respective collections of in parallel with assigning at least one second row of the sparse matrix to respective collections, and performing at least one mathematical operation on at least a first collection of the plurality of collections in parallel with performing the at least one mathematical operation on at least a second collection of the plurality of collections.

### BACKGROUND

A “sparse” matrix is one that includes relatively few nonzero-value elements. Sparse Matrix-Vector Multiply (SpMV) and other sparse matrix linear algebra are key operations in graph analytics, machine learning, and many other processing tasks. The number of non-zero elements within a row (a.k.a. row length) may be highly variable in a sparse matrix, and therefore using a different approach for sparse matrix operations than for other matrix operations improves the efficiency of the processing unit.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an example processing system for parallel processing of sparse matrix linear algebra in a computing system.

FIG. 2 is a diagrammatic view of a process for binning rows of a sparse matrix for parallel processing of sparse matrix linear algebra in a computing system.

FIG. 3 is a diagrammatic view of a process for assigning matrix rows to processing workgroups for a sparse matrix for parallel processing of sparse matrix linear algebra in a computing system.

FIG. 4 is a flow chart illustrating an example method for parallel processing of sparse matrix linear algebra in a computing system.

Throughout the drawings, identical reference characters and descriptions indicate similar, but not necessarily identical, elements. While the examples described herein are susceptible to various modifications and alternative forms, specific implementations have been shown by way of example in the drawings and will be described in detail herein. However, the example implementations described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

Parallel processing, such as by multiple cores of a processing unit, can offer significant performance and efficiency advantages in many computing contexts. The present disclosure is generally directed to parallel processing of sparse matrix linear algebra, which is a key set of operations in many processing contexts. Providing a different processing approach for sparse matrices than for regular matrices can result in a significant performance improvement by eliminating a large number of zero-value computations. Although approaches exist for sparse matrix linear algebra, such known approaches are not easily adaptable to parallel processing. As a result, parallel processing for sparse matrix linear algebra according to the present disclosure offers both computing performance and efficiency improvements over known approaches.

Performing parallel sparse linear algebra, such as SpMV, requires balancing a host of different—and sometimes conflicting—performance considerations. These include thread runtime divergence and device occupancy (especially on graphical processing units (GPUs)). A simple SpMV that assigns one thread per matrix row may perform poorly due to long latency tails with irregular row lengths, but another SpMV that uses multiple threads (or, for instance, a full GPU workgroup) per row would suffer from poor device occupancy with shorter rows. Preprocessing the input matrix to assign specific rows to specific workgroups based on row length can mitigate this issue, but preprocessing is generally serial and slow, which can limit the utility of such approaches. In particular, assigning rows to workgroups, under known approaches, was necessarily serial so as to avoid competing edits to row-size groupings in memory. The instant disclosure addresses that limitation by parallelizing multiple aspects of preprocessing and thereby providing increased performance and efficiency in a sparse matrix mathematical operation.

An approach for parallelized processing for sparse matrix linear algebra can include counting, for each row in the matrix, the quantity of nonzero values in the row and binning like-valued rows together for further processing. In some embodiments, a base-2 logarithm (log 2) of each row's nonzero value quantity may be calculated, and rows may be binned on the basis of their log 2 values. Binning may be performed efficiently and in parallel by creating bin data structures in memory and, in parallel, counting row nonzero values, calculating log 2 values, and appending row pointers (which may be memory pointers or other logical identifiers) to appropriate bins on the basis of the log 2 values. In some embodiments, such logical identifiers may be appended to bins through the use of atomic operations to ensure that data in a particular bin is not inadvertently overwritten by data respective of another row, which the inventors have appreciated avoids the above-noted necessity of serializing the assignment of rows to bins via inefficient techniques such as mutex locks. Once the rows of the sparse matrix are binned, appropriate processing techniques may be applied to bins of different log 2 value sizes, with the processing techniques selected according to performance of the various techniques on particular quantities of values and for particular mathematical operations. For example, “short row” bins may be processed according to an approach which streams data into local scratchpad memory for a full GPU workgroup comprised of many short rows; “medium row” bins may be processed according to an approach which uses one GPU workgroup to process each row; “long rows” may be processed according to an approach that uses multiple workgroups to cooperatively process each row.

In a first aspect of the present application, a processing unit including a plurality of processing cores is provided. The processing unit is configured to arrange a sparse matrix for parallel performance, by the plurality of processing cores of the processing unit, of at least one operation on different rows of the sparse matrix, wherein the processing unit is configured to arrange the sparse matrix for the parallel performance at least in part by calculating, for each row of a plurality of rows of the sparse matrix, a respective quantity of non-zero elements in the row, and assigning each row of the sparse matrix to a respective collection of a plurality of collections for parallel performance of the at least one operation on the sparse matrix, wherein the processing unit is configured to operate the plurality of processing cores to assign multiple rows of the sparse matrix to respective collections of the plurality of collections in parallel, and wherein the processing unit is configured to assign each row to the respective collection according to the respective quantity of non-zero elements for the row, wherein the processing unit is configured to operate the plurality of processing cores to perform the at least one operation on multiple collections of the plurality of collections in parallel, each of the multiple collections including one or more rows of the sparse matrix.

In an embodiment of the first aspect, the processing unit is configured to assign each row of the sparse matrix to the respective collection of the plurality of collections at least in part by adding the row to the respective collection using an atomic operation.

In an embodiment of the first aspect, the processing unit is configured to assign each row of the sparse matrix to the respective collection of the plurality of collections at least in part by adding a pointer to the row to a data storage for the respective collection.

In an embodiment of the first aspect, the processing unit is configured to perform the at least one operation with the plurality of collections at least in part by performing the at least one operation using a first processing technique for the first collection and a second processing technique for the second collection, the first processing technique and the second processing technique being different processing techniques.

In an embodiment of the first aspect, applying a respective processing technique to each respective collection includes applying each respective processing technique with a respective kernel of plurality of kernels, applying all of the respective processing techniques using a single kernel, and applying a respective local scratchpad memory usage technique of a plurality of local scratchpad memory usage techniques to each respective collection, or applying all of the respective processing techniques using a single kernel that iteratively processes the collections.

In an embodiment of the first aspect, the processing unit performs the assigning for multiple rows in parallel by the plurality of cores of the processing unit, and/or the processing unit performs the calculating for multiple rows in parallel by the plurality of cores of the processing unit.

In an embodiment of the first aspect, the processing unit is further configured to sort the rows in a collection in memory according to respective locations of the associated rows in the matrix.

In an embodiment of the first aspect, performing the operation includes assigning at least one respective processing workgroup of a plurality of processing workgroups to each collection.

In an embodiment of the first aspect, assigning each row to the respective collection according to the respective quantity of non-zero elements for the row includes calculating a base-2 logarithm of the respective quantity of non-zero elements and assigning each row to the respective collection according to the base-2 logarithm.

In a second aspect of the present disclosure, a computer-implemented method is provided that includes calculating, for each row of a plurality of rows of a sparse matrix, a respective quantity of non-zero elements, wherein the calculating is performed for multiple rows in parallel by multiple cores of a processing unit, for each row, appending, to a respective collection of a plurality of collections in a memory, a pointer to the row according to the respective quantity of non-zero elements for the row, wherein the processing unit performs the appending for multiple rows in parallel by multiple cores of the processing unit, and applying a respective processing technique to each respective collection, wherein a first processing technique applied to a first collection of the plurality of collections is different from a second processing technique applied to a second collection of the plurality of collections.

In an embodiment of the second aspect, the method further includes assigning multiple rows to collections in parallel by multiple cores of the processing unit.

In an embodiment of the second aspect, the method further includes sorting rows within a collection in memory according to respective locations of the associated rows in the matrix.

In an embodiment of the second aspect, the method further includes calculating a base-2 logarithm of the respective quantity of non-zero elements and assigning each row to a collection according to the base-2 logarithm.

In an embodiment of the second aspect, applying the respective processing technique to each respective collection includes assigning at least one respective processing workgroup of a plurality of processing workgroups to each collection and performing the respective processing technique with each processing workgroup.

In an embodiment of the second aspect, applying the respective processing technique to each respective collection includes processing a predetermined number of rows of the collection at a time.

In a third aspect of the present disclosure, a computing system is provided that includes at least one storage and at least one multi-core processing unit configured to generate, in the at least one storage, a plurality of collections, assign each row of a matrix including a plurality of rows to a collection according to a respective quantity of non-zero value elements in the row, for each row, atomically append, to the respective assigned collection, a pointer to the row, wherein the processing unit performs the appending for multiple rows in parallel by multiple cores of the processing unit, and perform an operation using the matrix, wherein performing the operation includes applying a respective processing technique to each respective collection, wherein a first processing technique applied to a first collection of the plurality of collections is different from a second processing technique applied to a second collection of the plurality of collections.

In an embodiment of the third aspect, assigning each row to the collection according to the respective quantity of non-zero elements for the row includes calculating a base-2 logarithm of the respective quantity of non-zero elements and assigning each row to the collection according to the base-2 logarithm.

In an embodiment of the third aspect, the processing unit is further configured to launch a plurality of kernels, wherein applying the respective processing technique to each respective collection includes applying each respective processing technique with a respective kernel of the plurality of kernels.

In an embodiment of the third aspect, the processing unit performs the assigning for multiple rows in parallel by multiple cores of the processing unit.

In an embodiment of the third aspect, the processing unit is further configured to sort the row pointers in the storage according to respective locations of the associated rows in the matrix.

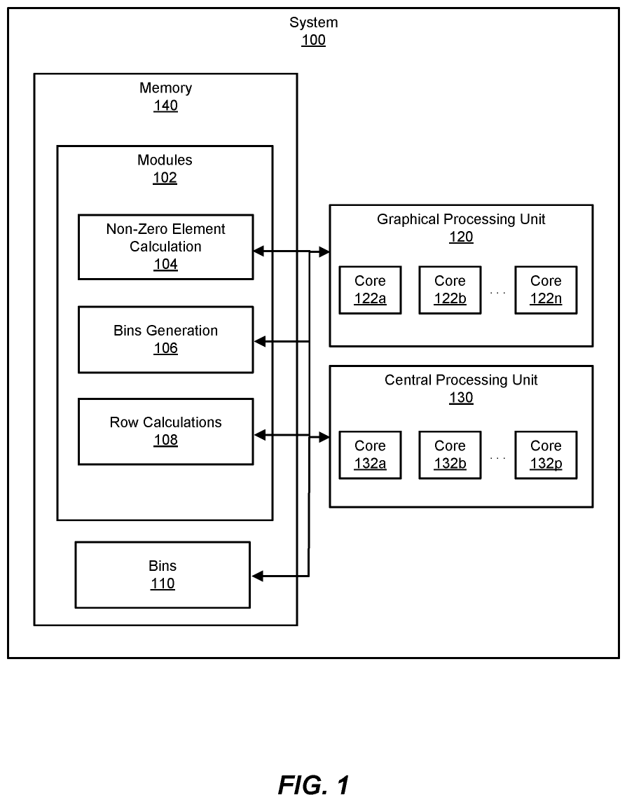

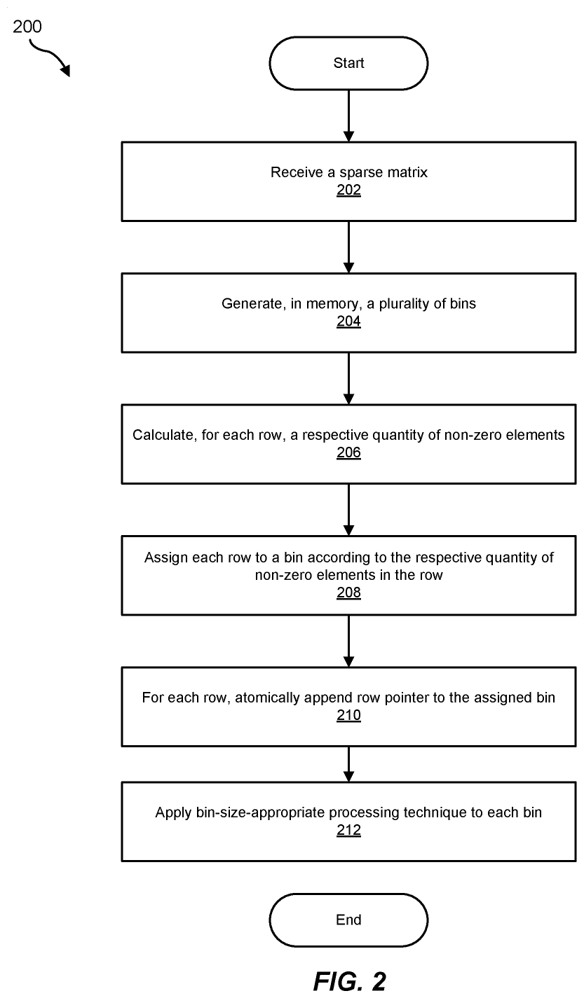

The following will provide, with reference to FIG. 1, a detailed description of an example computing system for parallel processing of sparse matrix linear algebra and example functionality of such a systemError! Reference source not found. A detailed description of a corresponding computer-implemented method will be provided in connection with FIGS. 2-4.

FIG. 1 is a block diagram of an example system 100 for parallel processing of sparse matrix linear algebra. As illustrated in this figure, example system 100 can include one or more modules 102 for performing one or more tasks. As will be explained in greater detail below, modules 102 can include a non-zero element calculation module 104, a bins generation module 106, and a row calculations module 108. Although illustrated as separate elements, one or more of modules 102 in FIG. 1 can represent portions of a single module or application.

In certain implementations, one or more of modules 102 in FIG. 1 can represent one or more software applications or programs that, when executed by a computing device, can cause the computing device to perform one or more tasks. For example, and as will be described in greater detail below, one or more of modules 102 can represent modules stored and configured to run on one or more computing devices, such as computing system 100. One or more of modules 102 in FIG. 1 can also represent all or portions of one or more special-purpose computers configured to perform one or more tasks.

As illustrated in FIG. 1, example system 100 can also include one or more memory devices, such as memory 140. Memory 140 generally represents any type or form of volatile or non-volatile storage device or medium capable of storing data and/or computer-readable instructions. In one example, memory 140 can store, load, and/or maintain one or more of modules 102. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

As illustrated in FIG. 1, example system 100 can also include one or more physical processors, such as graphical processing unit 120 and central processing unit 130. In one example, graphical processing unit 120 and central processing unit 130 can access and/or modify one or more of modules 102 stored in memory 140. Additionally or alternatively, graphical processing unit 120 and central processing unit 130 can execute one or more of modules 102 to facilitate parallel processing of sparse matrix linear algebra and the computing operations in which sparse matrix linear algebra is used, applied, etc.

The graphical processing unit 120 may include a plurality of processing cores 122a, 122b, . . . 122n (which may be referred to collectively as the cores 122 or individually as a core 122). The cores 122 may perform processing tasks independent of one another. Alternatively, two or more of the cores 122 may be grouped into a workgroup for joint or collective processing of a given task. In some embodiments, the cores 122 may be divided into a plurality of workgroups, with each workgroup being assigned and executing a respective processing task. Accordingly, an individual core (e.g., core 122a) of the graphical processing unit 120 may perform a processing task in parallel with one or more other cores 122 preforming another processing task. Further, a core workgroup may perform a respective processing task in parallel with one or more other core workgroups.

Similarly, the central processing unit 130 may include a plurality of processing cores 132a, 132b, . . . 132p (which may be referred to collectively as the cores 132 or individually as a core 132). The cores 132 may perform processing tasks independent of one another. Alternatively, two or more of the cores 132 may be grouped into a workgroup for joint or collective processing of a given task. In some embodiments, the cores 132 may be divided into a plurality of workgroups, with each workgroup being assigned and executing a respective processing task. Accordingly, an individual core (e.g., core 132a) of the central processing unit 130 may perform a processing task in parallel with one or more other cores 132 preforming another processing task. Further, a core workgroup may perform a respective processing task in parallel with one or more other core workgroups.

As will be appreciated by a person of skill in the art, the graphical processing unit 120 may have a greater number of cores 122 than the number of cores 132 in the central processing unit 130, but each core 132 of the central processing unit 130 may operate at a higher speed, or may be capable of more generalized tasks, relative to a single core of the graphical processing unit 120.

In general, the modules 102, as executed by one or more cores 122, 132, and/or one or more core workgroups, may perform parallel pre-processing and processing of sparse matrix linear algebra, in addition to other processing tasks. The sparse matrix may be received from a source outside of the system 100 (e.g., another computing system), or may be generated by the system 100 in the course of a larger processing task. The matrix may be defined as sparse, and thus preprocessed and processed using the modules 102, in data or metadata associated with the matrix, for example. The non-zero element calculation module 104 may be configured to determine, for a given matrix, a quantity of nonzero data values in each row of the matrix. This value—the quantity of nonzero values in a row—is referred to herein as the “length” of the row. In turn, the bins generation module 106 may generate collections of rows and groupings of rows-such groupings or collections being referred to herein as “bins”—as well as defining bin data structures 110 (which may be referred to herein as “bins 110”) in the memory 140. The row calculations module 108 may apply one or more processing techniques to the bins 110 to process each row of the matrix. As will be described below, each module 104, 106, 108 may include parallel processing aspects, each of which contributes to the efficiency of the system 100 for sparse matrix operations.

Many other devices or subsystems can be connected to system 100 in FIG. 1. Conversely, all of the components and devices illustrated in FIG. 1 need not be present to practice the implementations described and/or illustrated herein. System 100 can also employ any number of software, firmware, and/or hardware configurations. For example, one or more of the example implementations disclosed herein can be encoded as a computer program (also referred to as computer software, software applications, computer-readable instructions, and/or computer control logic) on a computer-readable medium.

The term “computer-readable medium,” as used herein, can generally refer to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The computing system 100, or one or more components thereof, may be or may be included in any computing context. For example, the computing system 100 may be a personal computer, and therefore may additionally include one or more I/O devices for use by an end user, such as a display, mouse, keyboard, etc., as well as one or more network interfaces for communications over one or more networks, such as a wide-area network, local area network, etc., one or more interfaces and devices for reading from and writing to physical media, such as an optical storage interface and drive, USB interface, hard disk interface and drive, and so on. In another example, the computing system 100 may be a server or may be a portion of a computing array, and accordingly may include one or more network interfaces for communicating with another system for coordinating the activities of the array.

FIG. 2 is a flow diagram of an example computer-implemented method 200 for parallel processing of a sparse matrix. The steps shown in FIG. 2 can be performed by any suitable computer-executable code and/or computing system, including system 100 in FIG. 1, and/or variations thereof. In one example, each of the steps shown in FIG. 2 can represent an algorithm whose structure includes and/or is represented by multiple sub-steps, examples of which will be provided in greater detail below. The operations included in the method 200 can be performed by the system 100 (e.g., by the graphical processing unit 120 and/or the central processing unit 130 executing one or more of the modules 104, 106, 108), in some embodiments.

In general, the method 200 includes operations 202, 204, 206, 208, 210 for arranging rows into collections of rows and an operation 212 for processing those rows once arranged. The arranging operations 202, 204, 206, 208, 210 may be considered preprocessing operations, in some embodiments.

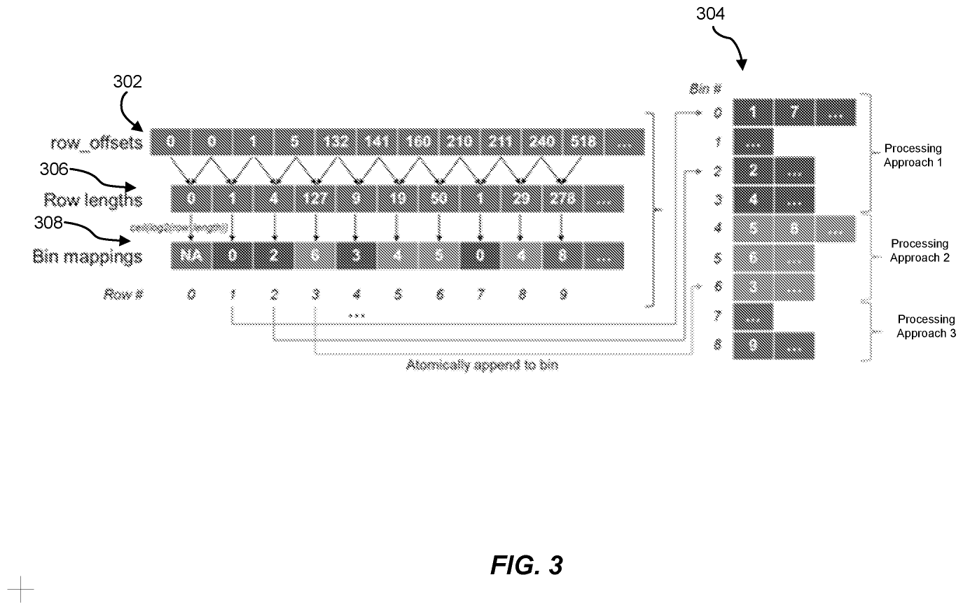

The method 200 of FIG. 2 will be described in conjunction with FIG. 3, which is a diagrammatic depiction of the operations of the method 200 as applied to an example sparse matrix. In the example of FIG. 3, a sparse matrix is represented in “Compressed Sparse Row” format by three indexed vectors 302, 306, 308, where each entry in the vector 302 correlates to a row—i.e., index [0] of the vector 302 correlates to row [0] of the matrix, index [1] correlates to row [1] of the matrix, and so on. The values in the vector 302 are offset values. Accordingly, each value v(i) for index i in the vector 302 represents the cumulative quantity of nonzero values in the matrix, with counting starting from row zero. Accordingly, after row [0] and row [1], there are zero cumulative nonzero values; after row [2] there is one cumulative nonzero value; after row [3] there are five cumulative nonzero values, and so on.

The method 200 may include, at operation 202, receiving a sparse matrix. The sparse matrix may be received by the computing system 100, the graphical processing unit 120, or the central processing unit 130, for example, from a separate computing device. Alternatively, the graphical processing unit 120 and/or the central processing unit 130 may receive the sparse matrix at operation 202 by having generated the sparse matrix in a previous processing operation.

The method 200 may further include, at operation 204, generating, in memory, a plurality of bins. For example, at operation 204, the graphical processing unit 120 and/or the central processing unit 130 (e.g., by executing the bins generation module 106, or a portion thereof), may define a plurality of data structures in the memory 140 (e.g., bins 110), each data structure corresponding to a respective bin. As will be described below, each bin may store matrix rows (or references, such as memory pointers to rows or other logical identifiers of rows) of a respective length, such that each bin stores a set of rows (or references to rows) of a length or lengths that is different from the rows and lengths stored in each other bin. FIG. 3 diagrammatically depicts a vector 304 of nine (9) bins, numbered [0], [1], . . . [8], each of which includes a plurality of pointers to respective matrix rows, as described below.

The method 200 may further include, at operation 206, calculating, for each row, a respective quantity of non-zero elements. Operation 206 may be performed by the nonzero element calculation module 104, for example, executed by the graphical processing unit 120 and/or the central processing unit 130. In some embodiments, operation 206 may include assigning one or more cores 122, 132 to each row of the plurality of rows of the matrix, and the separate one or more cores 122, 132 calculating a row length for multiple rows in parallel with the other cores. Further, in some embodiments, operation 206 may include assigning each row to a workgroup of cores 122, 132, and each workgroup calculating a row length for a respective assigned one or more rows in parallel with the other workgroups.

FIG. 3 illustrates a particular approach to calculating row lengths in operation 206. In the illustrated example, row lengths may be calculated based on the offset vector 302. Specifically, from the offset vector 302, the quantity of nonzero values in a given row i, where a value in the vector is v(i) may be calculated as (v(i)-v(i−1)) with row length for index [0] equal to v[0]. Example calculation results are shown in the example row length vector 306. As illustrated, the row length for row [1] is (v[1]−v[0]=0−0=0); the row length for row [2] is (v[2]−v[1]=1−0=1); the row length for row [3] is (v[3]−v[2]=5−1=4); the row length for row [4] is (v[4]−v[3]=132−5=127), and so on.

The method 200 may further include, at operation 208, assigning each row to a bin according to the respective quantity of non-zero elements in the row (e.g., as calculated in operation 206). Operation 206 may be performed by the bins generation module 106, for example, executed by the graphical processing unit 120 and/or the central processing unit 130. In some embodiments, operation 208 may include performing a secondary calculation on the length of each row. For example, operation 206 may include calculating a base-2 logarithm (“log 2”) of the row length and assigning rows to bins based on the log 2 length of the row. For example, in some embodiments, each bin may be associated with a respective log 2 length range, with each bin's range unique, different from, and non-overlapping with the range of each other bin. In some embodiments, each bin may be associated with a single respective log 2 value.

FIG. 3 illustrates a vector 308 of bin assignments, or bin mappings, determined according to log 2 values of the row lengths in vector 306. As shown, row [0] is not binned, as is has no nonzero values and thus does not need to be processed; row [1] is assigned to bin [0] because (log 2 (1)=0); row [2] is assigned to bin [2] because (log 2 (4)=2); row [3] is assigned to bin [6] because (log 2 (127)=6), and so on. In the illustrated example, each bin is associated with a single respective log 2 value. In other embodiments, a single bin may contain a range including a plurality of log 2 values. For example, each bin may include two log 2 values, such that a first bin may include log 2 values of one and two, a second bin may include log 2 values of three and four, and so on.

The method 200 may further include, at operation 210, for each row, adding the row to its assigned bin. In some embodiments, operation 210 may include atomically appending a respective pointer, such as a memory pointer or other logical identifier, for each row to the assigned bin. Operation 210 may be performed by the bins generation module 106, for example, executed by the graphical processing unit 120 and/or the central processing unit 130. In some embodiments, operation 210 may include assigning one or more cores 122, 132 to each row of the plurality of rows of the matrix, and the separate one or more cores 122, 132 adding a row to its assigned bin in parallel with the other cores adding other rows to their respective bins. Further, in some embodiments, operation 206 may include assigning each row to a workgroup of cores 122, 132, and each workgroup adding a row to its assigned bin in parallel with the other workgroups adding other rows to their respective bins. When operation 210 is performed using atomic operations for adding row pointers to bins—in which only one process at a time can access a particular memory portion associated with an index in a bin—the risk of competition for a specific index in a bin, or of a row pointer being inadvertently overwritten as a result of two cores or two workgroups attempting to write to the same index in the same bin at the same time, is eliminated. As a result, rows may be added to bins in a parallelized process, and that process may be scaled to the size of the matrix, resulting in improved efficiency relative to known processes.

Referring again to FIG. 3, each bin of the bins in vector 304 includes pointers to the rows assigned at operation 208 and written at operation 210. As shown, bin [0], corresponding to a log 2 row length of zero, includes pointers to rows [1] and [7] of the matrix; bin [2], corresponding to a log 2 row length of two, includes a pointer to row [2] of the matrix; bin [3], corresponding to a log 2 row length of three, includes a pointer to row [4] of the matrix; bin [4], corresponding to a log 2 row length of four, includes a pointer to rows [5] and [8] of the matrix, and so on. As in the example of FIG. 3, in some embodiments, each bin may be a data structure (e.g., an array) including one or more indexed pointers to rows of the sparse matrix, with each row represented up to once in the set of bins collectively. Accordingly, each bin may store unique data (e.g., pointers) with respect to each other bin.

In some embodiments, operation 210 may additionally include sorting each bin, e.g., sorting the order of row pointers within each bin. Sorting row pointers within bins may improve memory usage of the method 200, by ensuring that rows within a bin are ordered, so when rows are recalled from memory for processing, close-by rows are recalled at the same time, which reduces the number of times that values are recalled from different portions of memory (e.g., different DRAM rows).

The method 200 may further include, at operation 212, applying a bin-size-appropriate processing technique to each bin (i.e., to the rows in each bin). Operation 212 may be performed by the row calculations module 108, for example, executed by the graphical processing unit 120 and/or the central processing unit 130. In some embodiments, operation 212 may include assigning one or more cores 122, 132 to each bin, and the separate one or more cores 122, 132 applying a chosen processing technique to its assigned bin in parallel with the other cores applying desired processing techniques to their respective bins. Further, in some embodiments, operation 212 may include assigning each bin to a workgroup of cores 122, 132, and each workgroup applying a desired processing technique to its assigned bin in parallel with the other workgroups applying desired processing techniques to their respective bins.

In some embodiments, different processing techniques may be more efficient for different row lengths, and thus different processing techniques may be applied to bins based on the row lengths associated with those bins. For example, such processing techniques that may be applied include various Compressed Sparse Row (“CSR”) techniques, such as CSR-Stream, CSR-Vector, CSR-Longrows, or another appropriate row processing technique. For example, CSR-Stream may be applied to the bins associated with the shortest row lengths, CSR-Vector may be applied to the bins associated with medium row lengths (i.e., longer than the row lengths for which CSR-Stream is applied), and CSR-Longrows may be applied to the bins associated with long row lengths (i.e., longer than the row lengths for which CSR-Vector is applied).

In some embodiments, the method 200 may include defining or launching the processing sets desired for matrix processing. For example, the method 200 may include launching a desired number of kernels (e.g., a plurality of kernels) where multiple kernels are to be used for parallel processing or preprocessing. Additionally or alternatively, the method 200 may include defining a plurality of core workgroups of a multi-core processor (e.g., graphical processing unit 120 or central processing unit 130) so that those workgroups may process or preprocess rows in parallel.

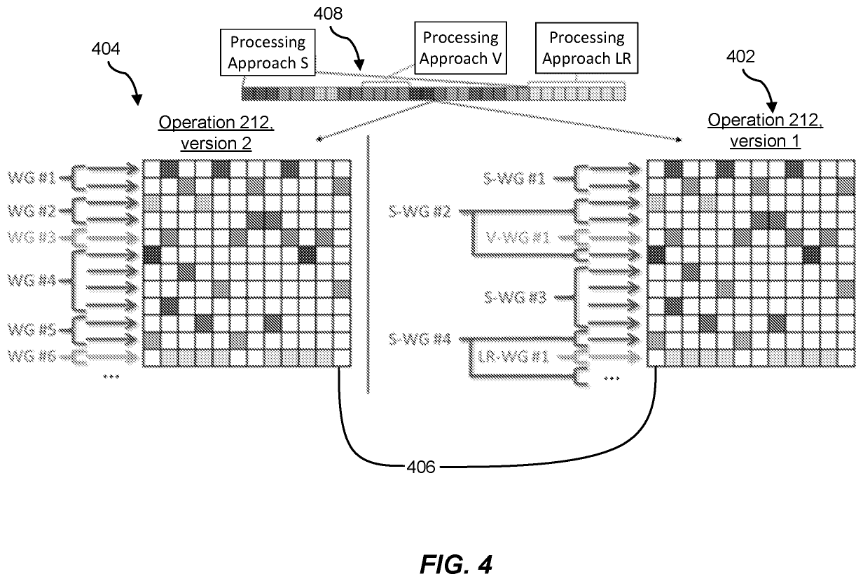

FIG. 4 illustrates two examples of the application of different processing techniques to different bins (e.g., operation 212), i.e., two versions of operation 212. At right table 402, a first version is shown. At left table 404, a second version is shown. Both versions are illustrated with respect to a matrix 406 (illustrated twice), which is represented by array 408 of the nonzero values from the matrix 406.

In the examples illustrated in FIG. 4, a first processing approach, Processing Approach S, is applied to rows having three or fewer nonzero values (corresponding to a log 2 bin value of one); a second processing approach, Processing Approach V, is applied to rows having between four and seven (inclusive) (corresponding to a log 2 bin value of two) nonzero values; and a third processing approach, Processing Approach LR, is applied to rows having eight or greater nonzero values (corresponding to a log 2 value of three or more).

In both versions illustrated in tables 402, 404, consecutive rows are assigned in sequence to a respective processing technique based on their length. Further, in the example of FIG. 4, a single workgroup of cores can apply Processing Approach S to up to six nonzero elements at a time. Thus, both versions in tables 402, 404 assign rows [0] and [1] (which collectively have six nonzero values) to a first workgroup (WG #1) for processing according to Processing Technique S. Further, in both versions, rows [2] and [3], which collectively have four nonzero elements, are assigned to a second workgroup (WG #2), before row [4] is encountered, which is assigned to a third workgroup (V-WG #1 in version 1; WG #3 in version 2) for application of Processing Approach V. First version in table 402 permits assigning nonconsecutive rows to a single workgroup. In contrast, second version in table 404 requires that rows be consecutive to be assigned to a workgroup together. Accordingly, in first version in table 402, the process recognizes that the workgroup has available capacity in addition to rows [2] and [3], and additionally assigns row [5] to WG #2, whereas the second version in table 404 assigns row [5] to a new workgroup, WG #4. Version #1 can improve workgroup utilization and therefore can offer greater processing efficiency relative to version #2. Simply stated, in version 1, rows are assigned to workgroups for application of a desired processing technique until the processing capacity of the workgroup is fully utilized, whereas in version 2, rows are assigned to workgroups for application of a desired processing technique until a discontinuity in row binning is encountered. In both versions, different workgroups may process their assigned rows in parallel with the other workgroups. Further, as a result, in version 1, a predetermined number of rows are processed by a workgroup at a time, wherein in version 2, a variable number of rows are processed by a workgroup at a time.

In some embodiments, method 200 may include preprocessing all rows of the sparse matrix according to operations 206, 208, 210 before beginning to process those rows at operation 212. In other embodiments, preprocessing and processing may occur in parallel. For example, rows may be assigned from bins to workgroups as the number of rows in a bin exceed a threshold, while further rows continue to be added to the bin.

FIG. 4 illustrates applying different processing techniques by different workgroups. In some embodiments, different processing techniques may be applied by different kernels. Still further, in some embodiments, different processing techniques may be applied by a single kernel, but with each technique applying a different respective local scratchpad usage technique that is most appropriate for the row lengths processed according to that approach. Still further, in some embodiments, different processing techniques may be applied by a single kernel, with the kernel proceeding through the different techniques in sequence and iteratively.

By joining similarly-sized rows into bins with each other, and applying a desired processing technique to a particular bin, the method 200 increases the efficiency of sparse matrix processing relative to known processes for multiple reasons. First, the most efficient technique for a given row length may be applied. Second, because several aspects of matrix preprocessing—determining row lengths, assigning rows to bins, and adding row pointers to bins—may occur in parallel for multiple rows at the same time, numerous preprocessing aspects are more efficient than known approaches. Third, because atomic operations may be used in the addition of rows to bins, those additions may occur in parallel, unlike in known approaches. In total, processing a sparse matrix according to the method 200 may provide a performance improvement of approximately 10-20× relative to the best known preprocessing-based approaches.

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of example system 100 in FIG. 1 can represent portions of a cloud-computing or network-based environment. Cloud-computing environments can provide various services and applications via the Internet. These cloud-based services (e.g., software as a service, platform as a service, infrastructure as a service, etc.) can be accessible through a web browser or other remote interface. Various functions described herein can be provided through a remote desktop environment or any other cloud-based computing environment.

In various implementations, all or a portion of example system 100 in FIG. 1 can facilitate multi-tenancy within a cloud-based computing environment. In other words, the modules described herein can configure a computing system (e.g., a server) to facilitate multi-tenancy for one or more of the functions described herein. For example, one or more of the modules described herein can program a server to enable two or more clients (e.g., customers) to share an application that is running on the server. A server programmed in this manner can share an application, operating system, processing system, and/or storage system among multiple customers (i.e., tenants). One or more of the modules described herein can also partition data and/or configuration information of a multi-tenant application for each customer such that one customer cannot access data and/or configuration information of another customer.

According to various implementations, all or a portion of example system 100 in FIG. 1 can be implemented within a virtual environment. For example, the modules and/or data described herein can reside and/or execute within a virtual machine. As used herein, the term “virtual machine” can generally refer to any operating system environment that is abstracted from computing hardware by a virtual machine manager (e.g., a hypervisor).

In some examples, all or a portion of example system 100 in FIG. 1 can represent portions of a mobile computing environment. Mobile computing environments can be implemented by a wide range of mobile computing devices, including mobile phones, tablet computers, e-book readers, personal digital assistants, wearable computing devices (e.g., computing devices with a head-mounted display, smartwatches, etc.), variations or combinations of one or more of the same, or any other suitable mobile computing devices. In some examples, mobile computing environments can have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein can be provided for a mobile computing environment and/or can interact with a mobile computing environment.

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein can also omit one or more of the steps described or illustrated herein or include additional steps in addition to those disclosed.

While various implementations have been described and/or illustrated herein in the context of fully functional computing systems, one or more of these example implementations can be distributed as a program product in a variety of forms, regardless of the particular type of computer-readable media used to actually carry out the distribution. The implementations disclosed herein can also be implemented using modules that perform certain tasks. These modules can include script, batch, or other executable files that can be stored on a computer-readable storage medium or in a computing system. In some implementations, these modules can configure a computing system to perform one or more of the example implementations disclosed herein.

The preceding description has been provided to enable others skilled in the art to best utilize various aspects of the example implementations disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A processing unit comprising a plurality of processing cores, the processing unit configured to:
arrange a sparse matrix for parallel performance, by the plurality of processing cores of the processing unit, of at least one operation on different rows of the sparse matrix, wherein the processing unit is configured to arrange the sparse matrix for the parallel performance at least in part by:
calculating, for each row of a plurality of rows of the sparse matrix, a respective quantity of non-zero elements in the row; and
assigning each row of the sparse matrix to a respective collection of a plurality of collections for parallel performance of the at least one operation on the sparse matrix, wherein the processing unit is configured to operate the plurality of processing cores to assign multiple rows of the sparse matrix to respective collections of the plurality of collections in parallel, and wherein the processing unit is configured to assign each row to the respective collection according to the respective quantity of non-zero elements for the row,
wherein the processing unit is configured to operate the plurality of processing cores to perform the at least one operation on multiple collections of the plurality of collections in parallel, each of the multiple collections comprising one or more rows of the sparse matrix.

2. The processing unit of claim 1, wherein the processing unit is configured to assign each row of the sparse matrix to the respective collection of the plurality of collections at least in part by adding the row to the respective collection using an atomic operation.

3. The processing unit of claim 1, wherein the processing unit is configured to assign each row of the sparse matrix to the respective collection of the plurality of collections at least in part by adding a pointer to the row to a data storage for the respective collection.

4. The processing unit of claim 1, wherein the processing unit is configured to perform the at least one operation with the plurality of collections at least in part by performing the at least one operation using a first processing technique for the first collection and a second processing technique for the second collection, the first processing technique and the second processing technique being different processing techniques.

5. The processing unit of claim 4, wherein applying a respective processing technique to each respective collection comprises:
applying each respective processing technique with a respective kernel of plurality of kernels;
applying all of the respective processing techniques using a single kernel, and applying a respective local scratchpad memory usage technique of a plurality of local scratchpad memory usage techniques to each respective collection; or
applying all of the respective processing techniques using a single kernel that iteratively processes the collections.

6. The processing unit of claim 1, wherein one or more of:
the processing unit performs the assigning for multiple rows in parallel by the plurality of cores of the processing unit; or
the processing unit performs the calculating for multiple rows in parallel by the plurality of cores of the processing unit.

7. The processing unit of claim 1, wherein the processing unit is further configured to sort the rows in a collection in memory according to respective locations of the associated rows in the matrix.

8. The processing unit of claim 1, wherein performing the operation comprises assigning at least one respective processing workgroup of a plurality of processing workgroups to each collection.

9. The processing unit of claim 1, wherein assigning each row to the respective collection according to the respective quantity of non-zero elements for the row comprises calculating a base-2 logarithm of the respective quantity of non-zero elements and assigning each row to the respective collection according to the base-2 logarithm.

10. A computer-implemented method comprising:
calculating, for each row of a plurality of rows of a sparse matrix, a respective quantity of non-zero elements, wherein the calculating is performed for multiple rows in parallel by multiple cores of a processing unit;
for each row, appending, to a respective collection of a plurality of collections in a memory, a pointer to the row according to the respective quantity of non-zero elements for the row, wherein the processing unit performs the appending for multiple rows in parallel by multiple cores of the processing unit; and
applying a respective processing technique to each respective collection, wherein a first processing technique applied to a first collection of the plurality of collections is different from a second processing technique applied to a second collection of the plurality of collections.

11. The method of claim 10, further comprising assigning multiple rows to collections in parallel by multiple cores of the processing unit.

12. The method of claim 10, further comprising sorting rows within a collection in memory according to respective locations of the associated rows in the matrix.

13. The method of claim 10, further comprising calculating a base-2 logarithm of the respective quantity of non-zero elements and assigning each row to a collection according to the base-2 logarithm.

14. The method of claim 10, wherein applying the respective processing technique to each respective collection comprises assigning at least one respective processing workgroup of a plurality of processing workgroups to each collection and performing the respective processing technique with each processing workgroup.

15. The method of claim 14, wherein applying the respective processing technique to each respective collection comprises processing a predetermined number of rows of the collection at a time.

16. A computing system comprising:
at least one storage; and
at least one multi-core processing unit configured to:
generate, in the at least one storage, a plurality of collections;
assign each row of a matrix comprising a plurality of rows to a collection according to a respective quantity of non-zero value elements in the row;
for each row, atomically append, to the respective assigned collection, a pointer to the row, wherein the processing unit performs the appending for multiple rows in parallel by multiple cores of the processing unit; and
perform an operation using the matrix, wherein performing the operation comprises applying a respective processing technique to each respective collection, wherein a first processing technique applied to a first collection of the plurality of collections is different from a second processing technique applied to a second collection of the plurality of collections.

17. The system of claim 16, wherein assigning each row to the collection according to the respective quantity of non-zero elements for the row comprises calculating a base-2 logarithm of the respective quantity of non-zero elements and assigning each row to the collection according to the base-2 logarithm.

18. The system of claim 16, wherein the processing unit is further configured to:
launch a plurality of kernels;
wherein applying the respective processing technique to each respective collection comprises applying each respective processing technique with a respective kernel of the plurality of kernels.

19. The system of claim 16, wherein:
the processing unit performs the assigning for multiple rows in parallel by multiple cores of the processing unit.

20. The system of claim 19, wherein the processing unit is further configured to sort the row pointers in the storage according to respective locations of the associated rows in the matrix.
